(19) United States
(12) Patent Application Publication
(10) Pub. No.: US 2011/0121014 A1
(43) Pub. Date: May 26, 2011

(54) METHOD AND APPARATUS FOR DOSING PRODUCTS

(75) Inventor: Volker Scheu, Niederzier (DE)

(73) Assignee: SIG TECHNOLOGY AG, Neuhausen Am Rheinfall (CH)

(21) Appl. No.: 12/989,291

(22) PCT Filed: Mar. 30, 2009
(86) PCT No.: PCT/DE09/00445

§ 371 Date: Dec. 29, 2010

(30) Foreign Application Priority Data
Apr. 22, 2008 (DE) 10 2008 020 751.9

(51) Int. Cl. B65D 83/00; B65G 59/00

(52) U.S. Cl. 221/151; 221/1

(57) ABSTRACT

Disclosed are a method and an apparatus for dosing products, a predefined amount of which is fed to a package. The dosed amount is defined by opening and closing at least one valve (1). A sleeve-type blocking element (4, 5) is arranged in a housing (3) of said valve (1). By placing said at least one blocking element (4, 5) in a manner that can be controlled or regulated, at least one recess (9, 10) located in the zone of lateral surfaces (7, 8) of the blocking element (4, 5) is disposed in such a way as to create an open or closed position and define a cross-section of an outlet 12). Preferably, the blocking elements (4, 5) are coaxially arranged relative to one another.

The invention relates to a method for metering products which are conveyed in a predetermined quantity to a package and in which a metered quantity is determined by opening and closing at least one valve.

The invention additionally relates to a device for metering products which are conveyed in a predetermined quantity to a package wherein the device has at least one valve which controls or regulates a product flow by opening and closing a conveying path, and which includes a valve housing in which a blocking element is positionably arranged in the conveying path.

Such devices and methods are used, for example, for filling and/or metering quantities of pourable, flowable or pasty products or products with piece-like portions, particularly also of foodstuff, for example, products like beverages, other liquid or pasty foodstuffs, of piece-like foodstuffs and/or mixtures or conglomerates of the above-mentioned foodstuffs or products. For filling such products, it is usually necessary to make available a large opening cross-section and, when the valve is closed, the product should be cut off if at all possible. Such requirements, also particularly exist in the field of aseptic filling of foodstuffs. For such aseptic applications, so-called pin-openings are commonly used. In the non-aseptic range, it is known in the art to use roller outlets or similar devices.

However, the previously known methods and devices cannot meet all requirements which are made up of a quick, reliable and problem-free filling.

Therefore, it is the object of the present invention to improve the method of the above-mentioned type in such a way that a quick and reliable filling procedure is realized while the product to be filled is manipulated gently.

In accordance with the invention, this object is met by a controllable or regulatable positioning of at least one cylinder-like locking element arranged in a valve housing of the valve, at least one recess is arranged in the area of side surfaces of the locking element for making available an opening or closing position and for securing a cross-section of an outflow opening.

Another object of the present invention is to construct a device of the above-mentioned type in such a way that a quick and gentle filling of the product is facilitated while the mechanical configuration of the metering device is simple.

In accordance with the invention, this object is met by providing a first as well as a second blocking element each with a cylindrical configuration and with at least one recess in the area of side surfaces, and the blocking elements are arranged relative to each other essentially coaxially.

The method of the invention and the device according to the invention make it possible to adapt the size of the resulting outlet opening variably to the product to be filled and to change the position of the outlet opening in a suitable way and manner. For avoiding filling material to be adhering at the material outlet, it is possible that the outlet is moved in a closed position in such a way that possibly an overhanging product can be stripped off, for example, from the housing wall into a waiting package. Moreover, intersections of closing edges are made available which lead to a clean separation and/or cutting of the product and thereby the occurrence of squeezed material, which is undesirable especially when filling foods, is avoided. Moreover, mechanical stops are avoided, so that a corresponding wear is kept low.

Compared to a blocking valve the outlet according to the invention prevents the generation of a pressure when the valve device is opened within the filling chamber. Moreover, the outlet does on its outer side not come directly into contact with the product, so that a product adherence at the outlet is minimized. Finally, the required force for opening and closing the metering device is independent of the pressure within the filling chamber, so that a drive for the locking elements having relatively small dimensions is sufficient.

The compact construction is achieved by coaxially positioning the locking elements relative to each other.

A simple controllability can be facilitated by positioning the blocking elements relative to each other by a rotary movement.

Assembly and disassembly procedures are facilitated by arranging the blocking elements so as to be displaceable relative to each other in an axial direction.

Particularly advantageous metering possibilities are made available by mounting both blocking elements in a valve housing so as to be moveable.

For adapting to special metering tasks, it is proposed that, by arranging the locking elements relative to each other and relative to the valve housing, a size of the outlet opening is predetermined.

For predetermining a metering quantity, it has been found advantageous that by arranging the blocking elements relative to each other and relative to the valve housing, a positioning of the outlet opening is provided.

In particular, it is also intended that by an arrangement of the blocking elements relative to each other and relative to the valve housing a size as well as a positioning of the outlet opening is predetermined.

In the drawings, embodiments of the invention are schematically illustrated. In the drawing

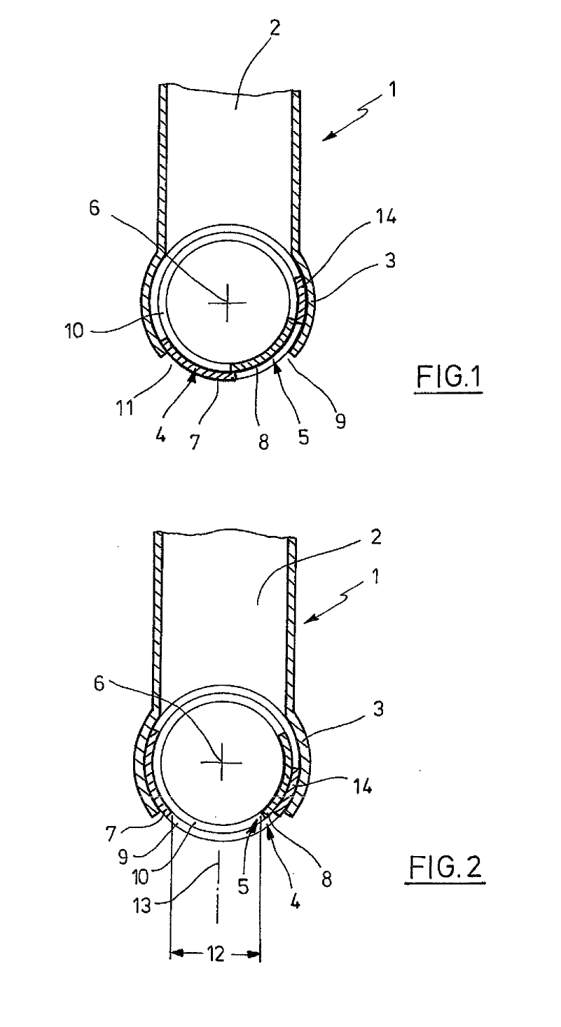

FIG. 1 is a cross-section of a valve with two sleeve-like locking elements arranged relative to each other essentially coaxially in a closed state of the valve.

FIG. 2 shows the arrangement according to FIG. 1 in an opened state of the valve, and

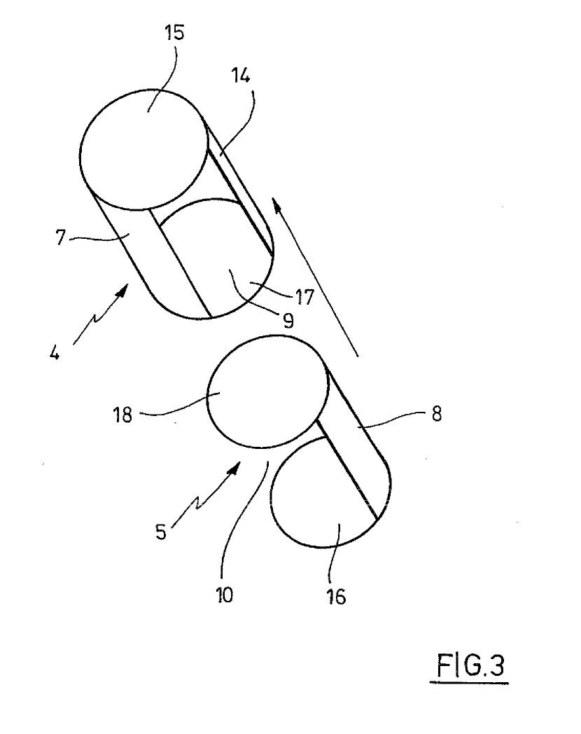

FIG. 3 is a perspective illustration of the two sleeve-like locking elements in a disassembled state.

In accordance with the embodiment of FIG. 1, the device for metering products is provided with a valve (1) which is arranged in the area of a conveying path (2). Within a valve housing (3) are arranged a first blocking element (4) and a second blocking element (5). Relative to a transverse axis (6), the blocking elements (4, 5) extend essentially coaxially relative to each other and in the manner of sleeves.

The arrangement of the structural elements takes place in such a way that the valve housing (3) is positioned on the outside and guides the first blocking element (4). The second locking element (5) is arranged within the first blocking element (4). The arrangement takes place especially in such a way that the first blocking element (4) is arranged so as to be moveable relative to the valve housing (3) and that the second blocking element (5) is moveably arranged within the first blocking element (4). In this connection, the mobility is realized by a rotatability of the structural elements relative to each other and about the transverse axis (6).

The blocking elements (4, 5) each have outer surfaces (7, 8) which are contoured in accordance with sections and segments of a cylinder wall. Respective recesses (9, 10) are arranged in the area of the outer surfaces (7, 8).

FIG. 1 shows an arrangement of the valve (1) in such a way that an outflow opening (11) of the valve housing (3) is closed by the outer surfaces (7, 8) of the blocking elements (4, 5). In this state of operation, it is not possible for product to be filled to emerge from the outlet opening (11).

In accordance with the state of operations shown in FIG. 2, the blocking elements (4, 5) have been turned relative to each other and relative to the valve housing (3) about the transverse axis (6) in such a way that the outlet openings (11) are released. The recesses (9, 10) of the blocking elements (4, 5) and the outlet opening (11) overlap each other at least in sections. FIG. 2 illustrates especially that as a result of an appropriate positioning of the blocking elements (4, 5) relative to each other and relative to the valve housing (3) the size of the resulting outlet opening (12) as well as the positioning of a surface centerline (13) can be changed and varied relative to the valve housing (3).

The predetermination of the effective size of the outlet opening (12) and the orientation of the surface centerline (13) can be reinforced in accordance with the embodiment in FIGS. 1 and 2 in particular by the fact that the first blocking element (4) is equipped with an outer surface (7) as well an outer surface (14) which are arranged at a distance relative to each other in a circumferential direction and limit the recess (9).

A positioning of the blocking elements (4, 5) relative to each other and relative to the valve housing (3) can be effected manually or automatically. An automatic positioning is considered especially when electrical or pneumatic positioning elements are used which act on the blocking elements (4, 5) either directly or with the intermediate arrangement of couplings, gear systems or other connecting devices.

FIG. 3 shows a perspective illustration of the two blocking elements (4, 5) which have been separated from each other and taken out of the valve housing (3). The cylindrical configuration of the blocking elements (4, 5) is further made clear as a result. In particular, it can be particularly seen that the blocking elements (4, 5) are each provided with a bottom (15, 16) and a cover (17, 18) at the ends of the respective cylindrical extensions. When the blocking elements (4, 5) are suitably sealed relative to the valve housing (3), it is not required that the bottoms (15, 16) and the covers (17, 18) have a closed surface configuration, but rather they can be constructed, for example, as guide rings or as another type of guide element.

The above explained sleeve-like configuration represents a particular embodiment of a cylindrical shape of the blocking elements (4, 5). Cylinder-like constructions encompass cone shaped or truncated cone-shaped configurations. The appropriate conical or cylindrical configuration can also be partially of solid construction, wherein through-channels extend in the solid construction.

As an alternative to making available the outlet opening by suitable rotary adjustment of the blocking elements (4, 5) it is also possible to provide the size and/or the position of the outlet opening by an axial positioning of the blocking elements (4, 5).

1. Method for metering products which are supplied in a predetermined quantity to a package, wherein a metered quantity is determined by opening and closing at least one valve, wherein, by a controllable or regulatable positioning of at least one cylindrical blocking element (4, 5) arranged in a valve housing (3) of the valve (1), at least one recess (9, 10) is arranged in the area of side surfaces (7, 8) of the blocking elements (4, 5) for making available an opening or closing position and for predetermining a cross-section of an outlet opening (12).

2. Method according to claim 1, wherein the blocking elements are positioned coaxially relative to each other.

3. Method according to claim 1, wherein the blocking elements (4, 5) are positioned relative to each other through a rotary motion.

4. Method according to claim 1, wherein the blocking elements (4, 5) are arranged so as to be movable relative to each other in an axial direction.

5. Method according to claim 1, wherein both blocking elements (4, 5) are moveably mounted in a valve housing (3).

6. Method according to claim 1, wherein a size of the outlet opening (12) is predetermined by an arrangement of the blocking elements (4, 5) relative to each other and relative to the valve housing (3).

7. Method according to claim 1, wherein by an arrangement of the blocking elements (4, 5) relative to each other and relative to the valve housing (3) a positioning of the outlet opening (12) is predetermined.

8. Method according to claim 1, wherein a size and positioning of the outlet opening are predetermined by an arrangement of the blocking elements (4, 5) relative to each other and relative to the valve housing (3).

9. Method according to claim 1, wherein sleeve-like blocking elements (4, 5) are positioned.

10. Method according to claim 1, wherein truncated cone-shaped blocking elements (4, 5) are positioned.

11. Method according to claim 1, wherein a size and/or a positioning of the positioning of the outlet opening (12) is predetermined by an axial displacement of at least one of the blocking elements (4, 5).

12. Device for metering products which are supplied in a predetermined quantity to a package, wherein the device has at least one valve, which controls or regulates a product flow by opening and closing a conveying path, and has a valve housing in which at least one blocking element is positionably arranged in the conveying path, wherein, a first blocking element as well as a second blocking element (4, 5) has a cylindrical configuration and is provided in the area of side surfaces (7, 8) with at least one recess (9, 10) each, and that the blocking elements (4, 5) are arranged essentially coaxially relative to each other.

13. Device according to claim 12, wherein the blocking elements (4, 5) are arranged so as to be rotatable relative to each other.

14. Device according to claim 12, wherein the blocking elements (4, 5) are arranged longitudinally slideable relative to each other.

15. Device according to claim 12, wherein the blocking elements (4, 5) are arranged so as to be rotatable relative to the valve housing (3).

16. Device according to claim 12, wherein at least one of the blocking elements (4, 5) is constructed sleeve-like.

17. Device according to claim 12, wherein at least one of the blocking elements (4, 5) is constructed so as to be truncated cone-shaped.

18. Device according to claim 12, wherein at least one of the recesses (9, 10) is defined by partial segments of a sleeve-like basic structure.
